(19) United States
(12) Patent Application Publication
(10) Pub. No.: US 2005/0033976 A1
(43) Pub. Date: Feb. 10, 2005

(54) Host intrusion detection and isolation

(75) Inventors: James M. Doherty, Georgetown, TX (US); Thomas Lee Adams, Austin, TX (US); Stephen Mark Mueller, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/634,117

(22) Filed: Aug. 4, 2003

(51) Int. Cl. H04L 9/00

(52) U.S. Cl. 713/200

(57) ABSTRACT

A host computer system having at least one network interface interfaced with a computer network is operated in a multi-user mode. An intrusion event is detected using a system daemon. In response to detecting the intrusion event, the at least one network interface is isolated from the computer network and the host computer system taken down to a single user state so that access to the host computer system is limited to physical access at the host computer system.

### BACKGROUND OF THE INVENTION

1. Field of the Disclosure

The present disclosure relates to methods and systems for intrusion detection.

2. Description of the Related Art

Intrusion detection and other forms of computer system security can be categorized as being either an external scheme or an internal scheme. Examples of external security elements include firewalls and routers. An example of an act performed by an external security element is port monitoring, which comprises watching traffic at critical incoming ports. External security elements may be used to provide protection against denial of service (DOS) attacks. Firewalls can also provide port forwarding and DMZ-type applications. External security elements often do not limit outgoing port connections.

Internal protection schemes are designed to prevent security breaches by use of file permission, directory access and execution permission. The aforementioned examples of internal protection are usually set as part of a computer's file system. Internal protection schemes prevent unauthorized users from accessing certain aspects of the system that could cause damage or provide unauthorized access to sensitive material.

### BRIEF DESCRIPTION OF THE DRAWINGS

The present invention is pointed out with particularity in the appended claims. However, other features are described in the following detailed description in conjunction with the accompanying drawing in which:

FIG. 1 is a schematic, block diagram of an embodiment of an intrusion detection system;

FIG. 2 is a flow chart of an embodiment of an intrusion detection method; and

FIG. 3 is an embodiment of a configuration file for use in intrusion detection.

### DETAILED DESCRIPTION OF THE PREFERRED EMBODIMENTS

Disclosed embodiments make use of several computer functions to provide comprehensive intrusion detection and appropriate isolation procedures. The procedures are implemented programmatically and executed in a real-time, continuous manner.

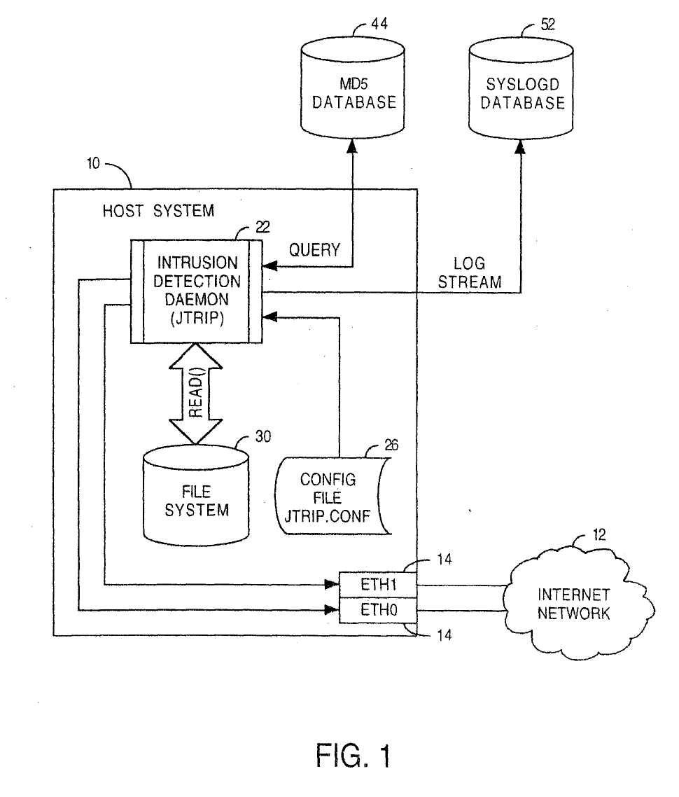

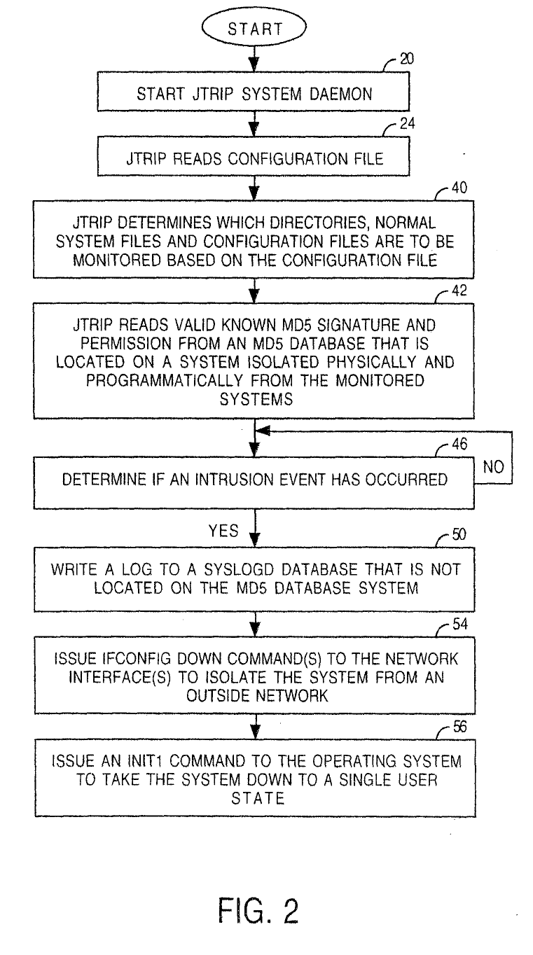

Particular embodiments are described with reference to FIG. 1, which is a schematic, block diagram of an embodiment of an intrusion detection system, and FIG. 2, which is a flow chart of an embodiment of an intrusion detection method. The system and method provide intrusion detection for a host system 10. The host system 10 comprises one or more computers that are accessible via a computer network 12. Examples of the host system 10 include, but are not limited to, a server computer, a corporate mainframe computer, and a desktop computer. Examples of the computer network 12 include, but are not limited to, an Internet, an intranet, an extranet, a local area network and a wide area network.

The host system 10 comprises a plurality of network interfaces 14 for interfacing with the computer network 12. For purposes of illustration and example, the host system 10 is depicted to have two network interfaces 14, although those having ordinary skill will recognize that the host system 10 may have an arbitrary number of network interfaces in practice. Examples of the network interfaces 14 include, but are not limited to, Ethernet interfaces.

As indicated by block 20, an intrusion detection system daemon 22 of the host system 10 is executed. The system daemon 22 may be started through a normal startup procedure of the host system 10. In embodiments where the host system 10 is UNIX-based, the system daemon 22 may comprise a JTRIP daemon as depicted in FIG. 1.

As indicated by block 24, the system daemon 22 reads a configuration file 26. The configuration file 26 may be named JTRIP.CONF as depicted in FIG. 1. The configuration file 26 indicates which directories and files in a file system 30 of the host system 10 are to be monitored by the system daemon 22.

The configuration file 26 comprises a script of a plurality of directives. The directives include a first directive type, “DIR”, that indicates a directory whose members (e.g., all of the files in the directory) are to be monitored by the system daemon 22. A second directive type, “FILE”, indicates a particular file that is to be monitored by the system daemon 22. A third directive type, “CONF”, indicates a configuration file that is to be monitored by the system daemon 22. The system daemon 22 monitors the configuration file identified by “CONF” on a different schedule than vendor-supplied control files identified by “DIR” and “FILE”.

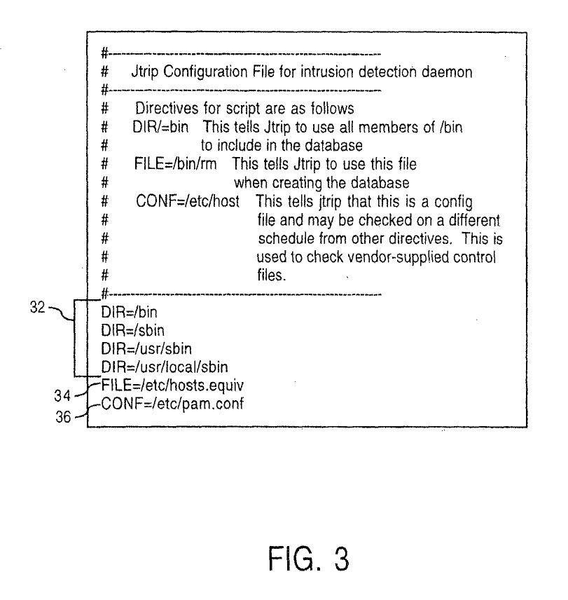

FIG. 3 shows an example of the configuration file 26. The configuration file 26 comprises four “DIR” directives 32 to tell the system daemon 22 to monitor all members of the /bin directory, the /sbin directory, the /usr/sbin directory, and the /usr/local/sbin directory for intrusion. A “FILE” directive 34 tells the system daemon 22 to monitor a file at /etc/hosts.equiv for intrusion. A “CONF” directive 36 tells the system daemon 22 to monitor a configuration file at /etc/pam.conf for intrusion, but at a different schedule than the other files and directories.

As indicated by block 40, the system daemon 22 determines which directories, system files and configuration files are to be monitored based on the configuration file 26.

As indicated by block 42, the system daemon 22 reads a valid known Message Digest 5 (MD5) signature and a correct permission for each file that is to be monitored. The aforementioned information is read from an MD5 database 44 located on a system isolated physically and programmatically from the host system 10. The MD5 signature comprises a 128-bit message digest for each file regardless of the length of the file. The MD5 signature for each file to be monitored is computed in advance and stored in the MD5 database 44.

As indicated by block 46, the system daemon 22 determines if an intrusion event has occurred. This act is performed repeatedly, for example multiple times (e.g., two or three times) per day.

The system daemon 22 detects an intrusion when a modification is made to any monitored file or directory in the file system 30, or when an incorrect permission is associated with any monitored file or directory in the file system 30, or when any monitored file or directory in the file system 30 has an improper ownership, or when any monitored file or directory in the file system 30 no longer exists. A modification to a monitored file is detected by computing a current MD5 signature of the monitored file in the file system 30, and comparing the current MD5 signature to the stored, trusted MD5 signature in the MD5 database 44. An intrusion event is detected if the two MD5 signatures differ.

If no intrusion event is detected, the host system 10 continues in its normal operating mode to allow external access thereto via the network interfaces 14. Typically, the normal operating mode is a multi-user state wherein multiple users can access the host system 10 via the computer network 12.

If an intrusion event is detected, the system daemon 22 generates an alarm. In response thereto, the host system 10 performs acts to protect the rest of the computer network 12 from a potentially-compromised system. As indicated by block 50, a log is written to a SYSLOGD database 52 that is not located on the host computer system 10 or the MD5 database system 44. The log indicates specifics of the intrusion event, such as a time, a date, which one or more files and/or directories triggered the intrusion event, a current MD5 signature associated with a modified file, and a cause of the intrusion event. The cause of the intrusion event may indicate a file or directory has been changed, a file or directory no longer exists, an incorrect permission, or an improper ownership.

As indicated by block 54, one or more commands are issued to the network interfaces 14 to isolate the host system 10 from the computer network 12. In one embodiment, the one or more commands may comprise one or more IFCONFIG down commands.

As indicated by block 56, one or more commands are issued to take the host system 10 down to a single user state. In one embodiment, the one or more commands comprise one or more INIT 1 commands issued by the operating system of the host system 10. As a result, access to the host system 10 is limited to physical access at the host system 10 itself, e.g., using a keyboard, pointing device, or other user-input device of the host system 10.

It is noted that the acts indicated by blocks 50, 54 and 56 can be performed either in a different order than depicted in FIG. 2, or in parallel, in alternative embodiments.

All communications of the system daemon 22 with the MD5 database 44 and the SYSLOGD database 52 are made via port forwarding using Secure Shell (SSH) tunneling or an alternative protocol to securely access a remote computer. This protects the communications from eavesdropping and man-in-the-middle attacks.

Those having ordinary skill will recognize that the herein-disclosed computer-implemented acts can be directed by computer-readable program code stored by a computer-readable medium. Examples of the computer-readable medium include, but are not limited to, a magnetic medium such as a hard disk or a floppy disk, an optical medium such as an optical disk (e.g., a CD or a DVD), or an electronic medium such as an electronic memory (e.g., a computer's internal memory or a removable memory such as a memory card).

It will be apparent to those skilled in the art that the disclosed embodiments may be modified in numerous ways and may assume many embodiments other than the particular forms specifically set out and described herein. For example, other data verification methods that map a file of arbitrary length to a fixed-length signature can be used in place of MD5. More generally, alternative data verification methods can be substituted for MD5.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method comprising:
providing a host computer system having at least one network interface interfaced with a computer network;
operating the host computer system in a multi-user mode;
detecting an intrusion event using a system daemon; and
in response to detecting the intrusion event, isolating the at least one network interface from the computer network and taking the host computer system down to a single user state so that access to the host computer system is limited to physical access at the host computer system.

2. The method of claim 1 wherein the system daemon comprises a JTRIP system daemon.

3. The method of claim 1 wherein said isolating the at least one network interface from the computer network comprises issuing an IFCONFIG down command to the at least one network interface.

4. The method of claim 1 wherein said taking the host computer system down to the single user state comprises issuing an INIT1 command to an operating system of the host computer system.

5. The method of claim 1 further comprising:
reading, by the system daemon, a configuration file that indicates at least one file in a file system of the host computer system to be monitored for intrusion.

6. The method of claim 5 wherein the configuration file comprises a first directive type that indicates a directory whose members are to be monitored for intrusion, a second directive type that indicates a file to be monitored for intrusion, and a third directive type that indicates another configuration file to be monitored for intrusion.

7. The method of claim 1 further comprising:
computing a data verification signature for a monitored file in a file system of the host computer system; and
comparing the data verification signature to a valid data verification signature for the monitored file;
wherein said detecting the intrusion event comprises detecting that the data verification signature differs from the valid data verification signature.

8. The method of claim 7 wherein the valid data verification signature comprises a Message Digest 5 (MD5) signature.

9. The method of claim 7 further comprising:
reading the valid data verification signature for the monitored file from a database that is located on a second computer system isolated physically and programmatically from the host computer system.

10. The method of claim 9 further comprising:
writing a log of the intrusion event to a log database that is not located on the host computer system or second computer system.

11. The method of claim I wherein said detecting the intrusion event comprises detecting an incorrect permission associated with a file in a file system of the host computer system.

12. The method of claim 1 wherein said detecting the intrusion event comprises detecting an incorrect ownership associated with a file in a file system of the host computer system.

13. The method of claim 1 wherein said detecting the intrusion event comprises detecting that a file no longer exists in a file system of the host computer system.

14. A method comprising:
providing a host computer system having at least one network interface interfaced with a computer network;
operating the host computer system in a multi-user mode;
executing a JTRIP system daemon on the host computer system;
reading, by the JTRIP system daemon, a configuration file that indicates at least one file in a file system of the host computer system to be monitored for intrusion, wherein the configuration file comprises a first directive type that indicates a directory whose members are to be monitored for intrusion, a second directive type that indicates a file to be monitored for intrusion, and a third directive type that indicates another configuration file to be monitored for intrusion;
reading a valid MD5 signature for a monitored file from a database that is located on a second computer system isolated physically and programmatically from the host computer system;
detecting an intrusion event using the JTRIP system daemon by detecting that an MD5 signature of the monitored file differs from the valid MD5 signature; and
in response to detecting the intrusion event:
issuing an IFCONFIG down command to the at least one network interface to isolate the at least one network interface from the computer network;
issuing an INIT1 command to an operating system of the host computer system to take the host computer system down to a single user state; and
writing a log of the intrusion event to a log database that is not located on the second computer system.

15. A system comprising:
a host computer system having at least one network interface interfaced with a computer network, the host computer system to:
operate in a multi-user mode;
detect an intrusion event using a system daemon; and
in response to detecting the intrusion event, isolate the at least one network interface from the computer network and take the host computer system down to a single user state so that access to the host computer system is limited to physical access at the host computer system.

16. The system of claim 15 wherein the system daemon comprises a JTRIP system daemon.

17. The system of claim 15 wherein the host computer system is to isolate the at least one network interface from the computer network by issuing an IFCONFIG down command to the at least one network interface.

18. The system of claim 15 wherein the host computer system is taken down to the single user state by issuing an INIT1 command to an operating system of the host computer system.

19. The system of claim 15 wherein the host computer system is further to read, by the system daemon, a configuration file that indicates at least one file in a file system of the host computer system to be monitored for intrusion.

20. The system of claim 19 wherein the configuration file comprises a first directive type that indicates a directory whose members are to be monitored for intrusion, a second directive type that indicates a file to be monitored for intrusion, and a third directive type that indicates another configuration file to be monitored for intrusion.

21. The system of claim 15 wherein the host computer system is further to:
compute a data verification signature for a monitored file in a file system of the host computer system; and
compare the data verification signature to a valid data verification signature for the monitored file;
wherein the intrusion event is detected by detecting that the data verification signature differs from the valid data verification signature.

22. The system of claim 21 wherein the valid data verification signature comprises a Message Digest 5 (MD5) signature.

23. The system of claim 21 further comprising:
a second computer system isolated physically and programmatically from the host computer system;
wherein the host computer system is to read the valid data verification signature for the monitored file from a database that is located on the second computer system.

24. The system of claim 23 further comprising:
a log database not located on the host computer system or the second computer system;
wherein the host computer system is further to write a log of the intrusion event to the log database.

25. The system of claim 15 wherein the intrusion event comprises an incorrect permission associated with a file in a file system of the host computer system.

26. The system of claim 15 wherein the intrusion event comprises an incorrect ownership associated with a file in a file system of the host computer system.

27. The system of claim 15 wherein the intrusion event comprises a file no longer existing in a file system of the host computer system.
